(19) United States
(12) Patent Application Publication
(10) Pub. No.: US 2024/0367310 A1
(43) Pub. Date: Nov. 7, 2024

(54) DURABLE RAILROAD BRAKE STICK

(71) Applicant: Precision Cut 3D LLC, Ogden, UT (US)

(72) Inventors: John Richard IRWIN, Ogden, UT (US); Dan B. Follett, Morgan, UT (US); William Edward Denslow, Ogden, UT (US)

(21) Appl. No.: 18/739,996

(22) Filed: Jun. 11, 2024

Related U.S. Application Data
(63) Continuation-in-part of application No. 17/875,091, filed on Jul. 27, 2022.
Application No. 17/875,091 is a continuation-in-part of application No. 17/183,124, filed on Feb. 23, 2021, now Pat. No. 11,597,416.
(60) Provisional application No. 62/981,504, filed on Feb. 25, 2020.

(51) Int. Cl. B25J 1/04; B61H 13/02

(52) U.S. Cl. CPC B25J 1/04; B61H 13/02

(57) ABSTRACT

A railroad brake stick includes a head made of non-metal material (e.g., polymer). The head includes a planar shape with a proximal end, a distal end, a lower side, and an upper side. The lower side includes a curved recess and the upper side on the distal end of the head includes a protrusion. The railroad brake stick further includes a substantially hollow shaft made of the composite material. The substantially hollow shaft includes a first end and a second end, the first end coupled to the proximal end of the head. The railroad brake stick further includes at least one magnet coupled to the substantially hollow shaft and an end cap coupled to the second end of the substantially hollow shaft.

### CROSS-REFERENCE TO RELATED APPLICATIONS

This patent application is a continuation-in-part of U.S. application Ser. No. 17/875,091 filed Jul. 27, 2022, which is a continuation-in-part of U.S. application Ser. No. 17/183,124 filed Feb. 23, 2021, which claims priority to U.S. Provisional Application No. 62/981,504 filed Feb. 25, 2020, which applications are incorporated herein by specific reference in their entirety.

### BACKGROUND

### Field

The present disclosure relates to railroad brake sticks.

### Description of Related Art

Previously, railroad brake sticks have been made of heavy metal materials. The construction of the prior railroad brake sticks was designed for a heavy metal object to interact with train components. As a result, prior railroad brake sticks were prepared from heavy metal materials with robust construction. However, the heavy railroad brake sticks are difficult to use due to the significant weight.

Attempts to improve railroad brake sticks have included designs of adjustable length sticks, such as the following: U.S. Pat. Nos. 8,434,802; 8,469,425; 8,469,426; 8,939,051; 10,759,453; D663,193, D676,735; D786,638; D760,564; D871,174; and D843,183, which are incorporated herein by specific reference in their entirety. However, the improved railroad brake sticks are now more complex and more difficult to manufacture and operate.

Thus, there is a need for a railroad brake stick that is lightweight and can be more easily and safely used for railroad operations, and which is strong and durable to be useful in the railroad environment for a long period of time.

### SUMMARY

In some embodiments, a railroad brake stick can include: a head including a planar body with a working region having a perimeter head shape with at least one working surface and with a hilt region having a hilt slot; a cross-support including a planar body with a support slot that mates with the hilt slot to form an interlocking coupling; an elongate handle with a substantially hollow shaft having a first end and a second end, the first end having a first opening receiving the hilt region and cross-support to have the interlocking coupling located within a lumen of the hollow shaft; a binder in contact with the lumen of the hollow shaft and in contact with the hilt region and cross-support so as to couple the hilt region and cross-support to the lumen of the hollow shaft; a handle cover over the elongate handle, wherein the elongate handle cover is a woven fiber; at least one magnet coupled to the elongate handle and covered by the handle cover; and an end cap coupled to the second end of the elongate handle.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIGS. 1A-1B show orthogonal cross-sectional views of a railroad brake stick having a head coupled to a cross-support member for stability and inserted into a handle.

FIGS. 2A-2B show orthogonal side views of the railroad brake stick.

FIGS. 3A-3B show a side view the head and cross-support of the railroad brake stick.

FIG. 4A shows a side view of a handle.

FIG. 4B shows a side view of the head and cross-support interlocked piece inserted into the handle to form the railroad brake stick.

FIG. 4C shows a cross-sectional view of the head and cross-support interlocked piece inserted into the handle.

FIG. 5A shows front top cross-sectional view of the head and cross-support interlocked piece.

FIG. 5B shows the lateral cross-sectional view of the head and cross-support interlocked piece.

FIG. 5C shows the side cross-sectional view of the head and cross-support interlocked piece.

FIG. 6 shows a side view of the railroad brake stick having the brace implant in the head.

FIG. 7 shows side views of planar brace implant shapes.

FIG. 8A shows a side view of the planar railroad brake stick head showing implant recesses formed therein, wherein the implant recesses are adapted to receive the brace implant.

FIG. 8B shows a bottom view that indicates placement of the implant recess in the proximal concave region of the railroad brake stick head.

FIG. 9A shows a side view of the railroad brake stick end cap including an engageable member extending vertically away from a nose for inserting into the substantially hollow shaft.

FIG. 9B shows an orthogonal view of the railroad brake stick end cap.

FIG. 9C shows a top view of the railroad brake stick end cap.

FIG. 9D shows a bottom view of the railroad stick end cap.

FIG. 10 shows a side view of the railroad brake stick coupled with the railroad stick end cap having the engageable member inserted in the handle.

FIG. 11 shows a side view of a brace implant having a concave working surface with another concave notch formed into the working surface.

FIG. 12A shows a top perspective view of a magnet brace adapted to hold a magnet and couple with a brake stick handle.

FIG. 12B shows a bottom perspective view of a magnet brace adapted to hold a magnet and couple with a brake stick handle.

FIG. 13A shows a perspective view of a hard neck cover adapted to cover the interface between the head and handle.

FIG. 13B shows a first cross-sectional view of FIG. 13A.

FIG. 13C shows a second cross-sectional view of FIG. 13A.

The elements and components in the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

In some embodiments, a lightweight and durable railroad brake stick is provided that can be used in a railroad setting. Previously, railroad brake sticks have been fairly well known, and prior brake sticks are quite heavy to lift at about 8 to 14 pounds. So, when trying to handle that type of weight in a stick form in the railroad environment, it is quite heavy for the user. As a result, the working end of an old railroad brake stick feels like it is unbalanced and it's difficult to use for the human user.

Now, the present railroad brake stick is a lightweight material (e.g., plastic, composite, or other material) device that is durable enough that it can be used in the same way as prior railroad brake sticks. The lightweight railroad brake stick is configured with similar dimensions and working head shape, so that it does the same thing as prior brake sticks. For example, the lightweight brake stick can be configured to have a very similar shaped working head as any other brake sticks. However, the structure of the new railroad brake stick is significantly different due to the nature of using the lightweight durable materials. The brake stick has the head at a distal end and a handle with an end cap at a proximal end. The brake stick has a proximal side which is close to the user and a distal side that's away from the user. The head has the proximal sides cut out to form a concave shape for a pull working surface and it has a distal protrusion that is aligned with the handle that can be used for a push working point. The head is attached to the handle and has a distal scoop (e.g., concave region, push working surface) and it also has the distal protrusion at the exterior of the head for a push working point. The head has some shapes that have some functionalities, such as pull or push work surfaces, but it looks and functions like a traditional brake stick. The figures illustrate the new railroad brake stick.

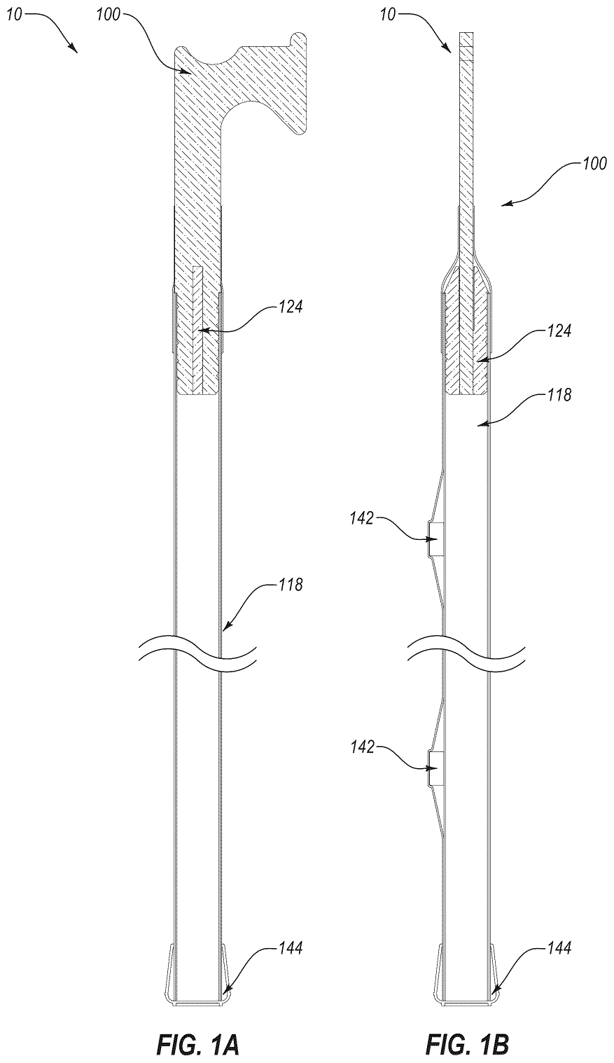

FIGS. 1A-1B show orthogonal cross-sectional views of a railroad brake stick 10 having a head 100 coupled to a cross-support member 124 for stability and inserted into a handle 118. At least two magnets 142 are included on the handle 118. An end cap 144 is included on the handle 118 opposite of the head 100. As shown, the head 100 and cross-support 124 are located within a lumen in the handle 118 at the distal end thereof.

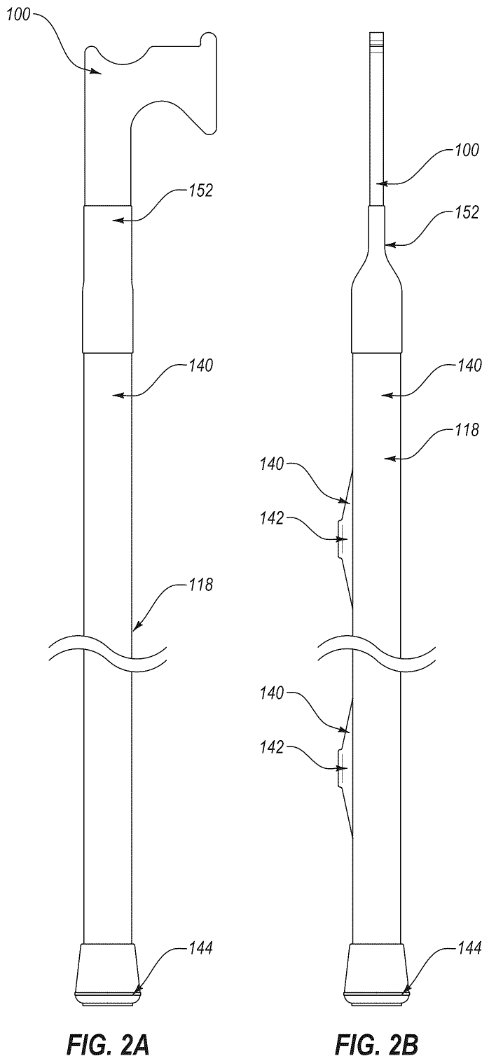

FIGS. 2A-2B show orthogonal side views of the railroad brake stick 10. A handle sleeve 140 is located over the handle and a proximal portion of the head 100. A neck cover 152 is positioned over a distal portion of the handle sleeve 140 and over a proximal portion of the head 100. Here, handle sleeve 140 is shown overlapping the handle 118 and overlapping a part of the head 100. The part of the head 100 that is covered with the handle sleeve 140 can be considered to be the hilt. The neck cover 152 is also shown overlapping on the hilt of the head 100.

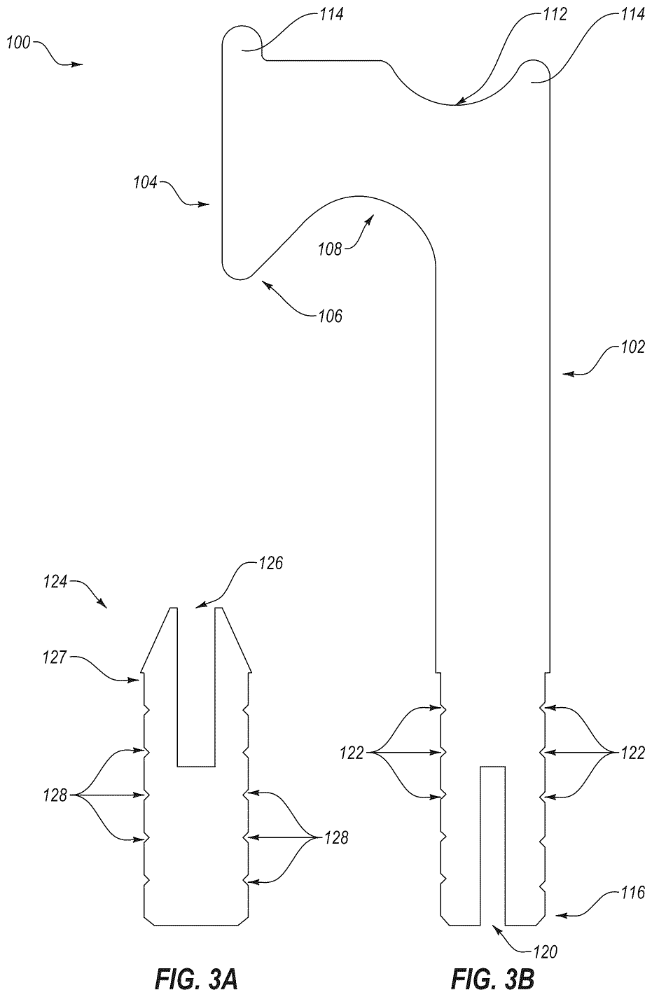

The FIGS. 3A-3B show a railroad brake stick head 100 having a planar shape with recesses (e.g., 112, 108) and/or protrusions (e.g., 114, 106) on one or more side surfaces of the planar shape, the planar shape having a head interlocking groove (e.g., slot 120) on a hilt region. The cross-support 124 has a planar shape with a support interlocking groove (e.g., slot 126) that can be interlocked with the head interlocking groove such that the planar shape of the head 100 is crossed with the planar shape of the cross-support 124 to form an interlocking region. FIGS. 1A-2B show the handle 118 is coupled to the head 100 and cross-support 124 such that the interlocking region is within an end of the handle 118. A handle sleeve 140 is over the handle 118 and optionally over a portion of the head 100. The neck cover 152 is over the distal part of the handle sleeve 140 and a proximal part of the hilt of the handle 118.

FIGS. 3A-3B show the head 100 and cross-support 124 of the railroad brake stick. The head 100 can have a hilt 102 and tool region 104 such that the tool region 104 extends laterally from the hilt 102. The tool region 104 includes a side edge with shapes formed therein to give the planar profile side view shape (FIG. 3B). The hilt 102 includes a coupling region 116 (e.g., interlocking region) opposite from the tool region 104, where the coupling region 116 is configured to be coupled with a handle 118. The coupling region 116 includes a slot 120 extending from an end of the hilt 102 toward the tool region 104 and includes at least one notch 122 on a side.

The cross-support 124 includes a slot 126 extending from an end of the cross-support 124 into the body to form a slot shape. The cross-support 124 includes at least one notch 128 on a side. The slot 120 of the head 100 is configured to receive a portion of the cross-support 124 therein and the slot 126 of the cross-support 124 receives a portion of the head 100 therein such that the head 100 and cross-support are interlocked in a tongue and groove manner to form an interlocking region corresponding to the coupling region 116 when interlocked.

The figures show that the head 100 has a hilt 102 and tool region 104 integrated together such that the tool region 104 extends laterally from the hilt 102. The tool region 104 includes a proximal side 106 having a concave region 108 and a distal side 110 having at least one concave region 112 or at least one protrusion 114, which can be used as work surfaces or work regions. The hilt 102 includes a coupling region 116 opposite from the tool region 104, wherein the coupling region 116 is configured to be coupled with a handle 118. The coupling region 116 includes a slot 120 extending from an end of the hilt 102 toward the tool region 104 and includes at least one notch 122 lateral of the slot 120.

A cross-support 124 including a slot 126 extending from an end of the cross-support 124 and including at least one notch 128 lateral of the slot 126. The slot 120 of the head 100 receives a portion of the cross-support 124 therein and the slot 126 of the cross-support 124 receives a portion of the head 100 therein such that the head 100 and cross-support are interlocked in a tongue and groove manner to form an interlocking region.

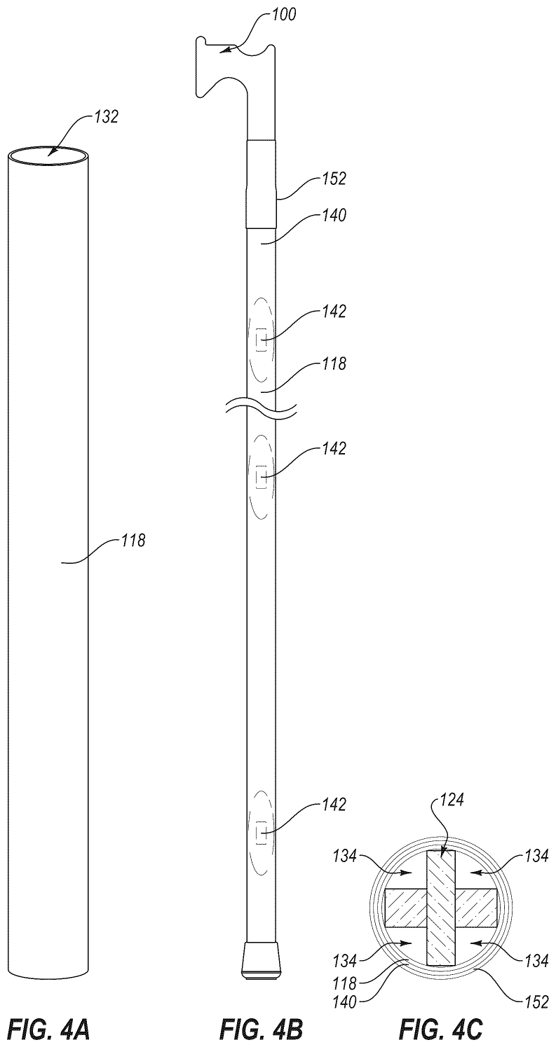

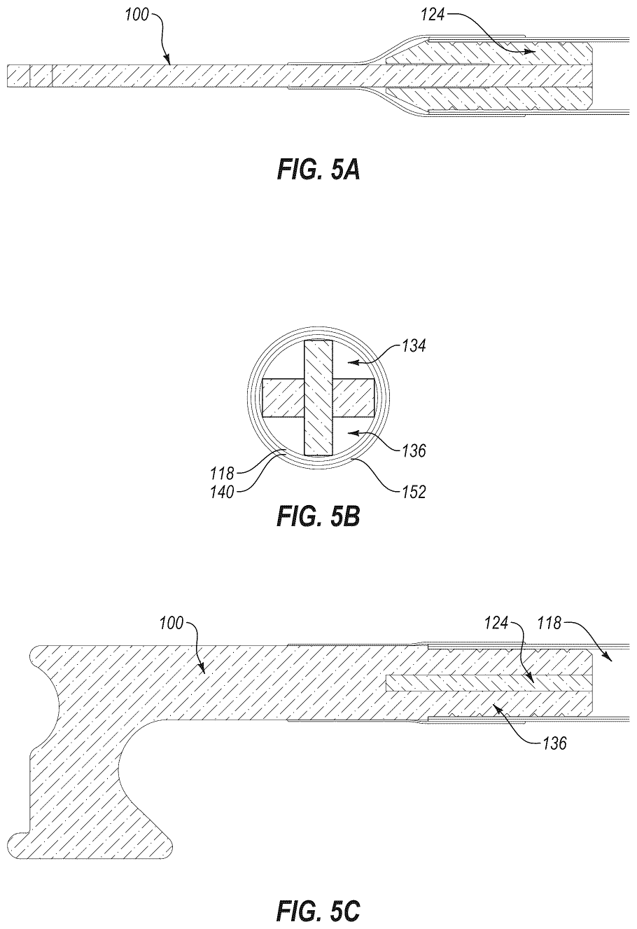

FIG. 4A shows the handle 118 to be coupled to the head 100, in which the handle 118 includes a conduit 132 dimensioned to receive the interlocking region of the interlocked head 100 and cross-support 124 therein so as to provide chambers 134 (e.g., FIG. 4C) between the interlocking region an internal surface of the conduit 132. The binder 136 of FIG. 5B) is located in the chambers 134 and in the notches 122 and notches 128 such that the binder 136 extends between the chambers 134 through the notches 122 and notches 128.

FIG. 4B shows the handle 118 coupled to the head 100, in which the handle 118 receives the interlocking region of the interlocked head 100 and cross-support 124 covered by the neck cover 152. A binder 136 is located in the handle 118 around head 100 and cross-support 124 as shown in FIG. 5B.

FIG. 5A shows the longitudinal cross-sectional view of the head 100 interlocked with the cross-support 124. FIG. 5B shows the lateral cross-sectional view of the head interlocked with the cross-support 124 to form the chambers 134 that are then inserted into the handle 118 in the form of a tube and then the binder 136 is inserted into the chambers 134. FIG. 5C shows the longitudinal cross-sectional view once the head 100 and interlocked cross-support 124 are locked into the handle 118 with the binder 136. Alternatively, the hollow handle 118 receives the binder, and then the head 100 is inserted into the binder already in the handle 118. The binder then pushes further into the tubular handle 118, which plugs the handle 118, fills gaps in the handle 118, and pushes some binder out of the opening of the handle 118, which can be cleaned. While the steps can be performed in any order, the result is the handle 118 having the binder with the head 100 forming an assembly that locks the head 100 to the handle 118.

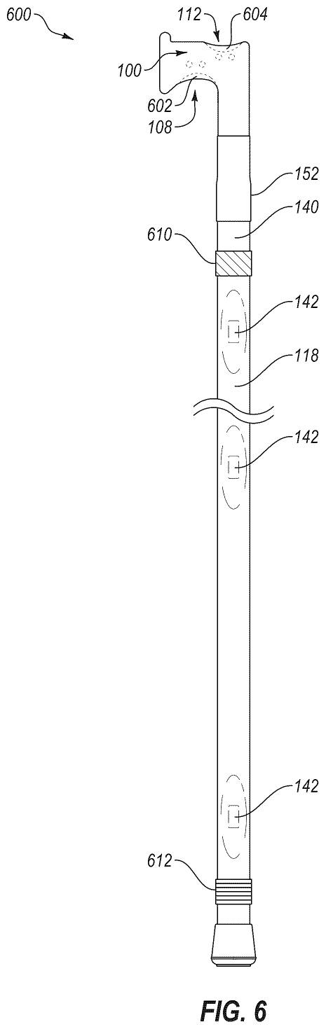

FIG. 6 illustrates another embodiment of a brake stick 600 that includes the features as described herein with modifications. The head 100 includes a brace implant 602 located in the proximal concave region 108. Optionally, the head 100 includes a second brace implant 604 located in the distal concave region 112. Accordingly, any embodiment can include at least one brace implant within any proximal or distal concave region. While not shown, a brace implant could also be included in any region of the head so as to protrude from any surface thereof, such as the end surface opposite of the hilt region.

The perimeter side connecting between the planar surfaces can include the brace implant 602 so that the use of the surface causes the brace implant 602 to receive the work. That is, the brace implant 602 is positioned to contact with a railroad element surface that is being worked with the brake stick 600. The pulling motion of the brake stick 600 can cause the proximal concave region 108 to work against a member of the railroad environment. For example, using the proximal concave region 108 to pull against a brake wheel causes wear in the proximal concave region 108. Now, the pulling force with the brake stick 600 can be against the brace implant 602. Accordingly, the brace implant 602 can be prepared from an extremely durable material, which is more durable than the head material. Similarly, the second brace implant 604 can be used for pushing work motions with the brake stick 600.

Accordingly, the head material can be a durable and light material to provide the structure and support for the railroad brake stick to allow easier use by the user. The brace implant is provided as a small member to act as the working surface to inhibit wear. The brace implant can be an extremely durable material, such as bronze or an alloy thereof, that can be wear-resistant in the railroad stick use environment. This allows for enhanced pulling operations without wearing the proximal concave region that is highly used during normal operations. Instead of the entire head being a highly durable material, the lightweight head can include the small brace implant to enhance usability of the railroad brake stick. The distal concave region can be similarly reinforced with a brace implant.

FIG. 6 also shows a reflective member 610 that includes a surface that reflects light. Additionally, FIG. 6 shows a phosphorescent member 612 that can glow in the dark. These members can enhance the ability to see the railroad brake stick, whether during the day (reflective) or night (glowing). These members can be patches, tapes, rings, wraps, or other attachment that are coupled to the handle sleeve of the railroad brake stick. Also, the reflective member 610 or phosphorescent member 612 can be placed at any location along the handle between the neck cover 152 and the end cap.

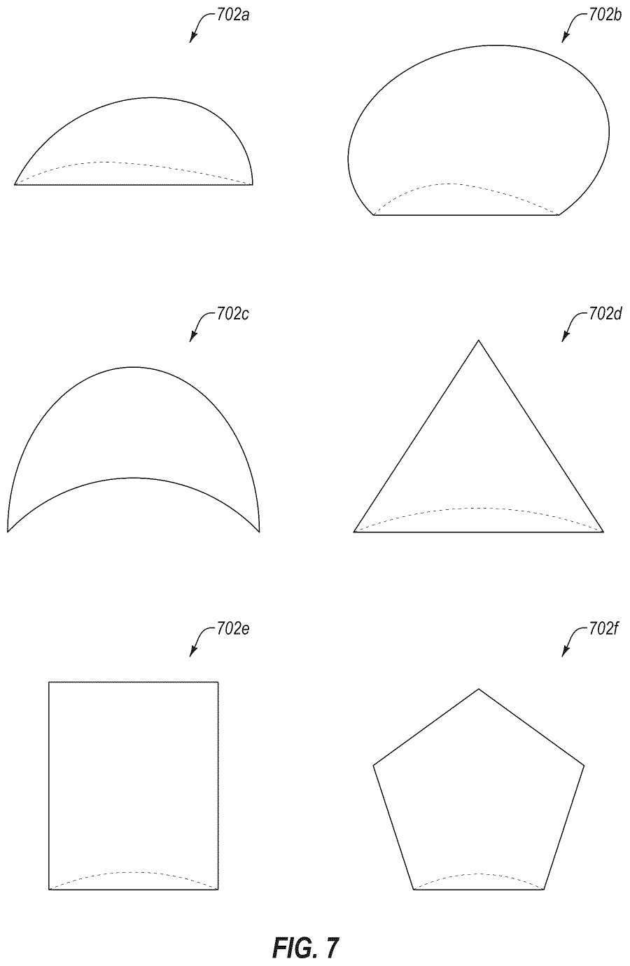

FIG. 7 illustrates different shapes of a planar brace implant 702a-702f that can be mounted to the head of the railroad brake stick. The dashed line represents a concaved work surface so that the proximal surface is concave instead of flat. As such, the working surface of the railroad brake stick that contacts the railroad elements is the surface of the planar brace implant 702a-702f that is concave or flat.

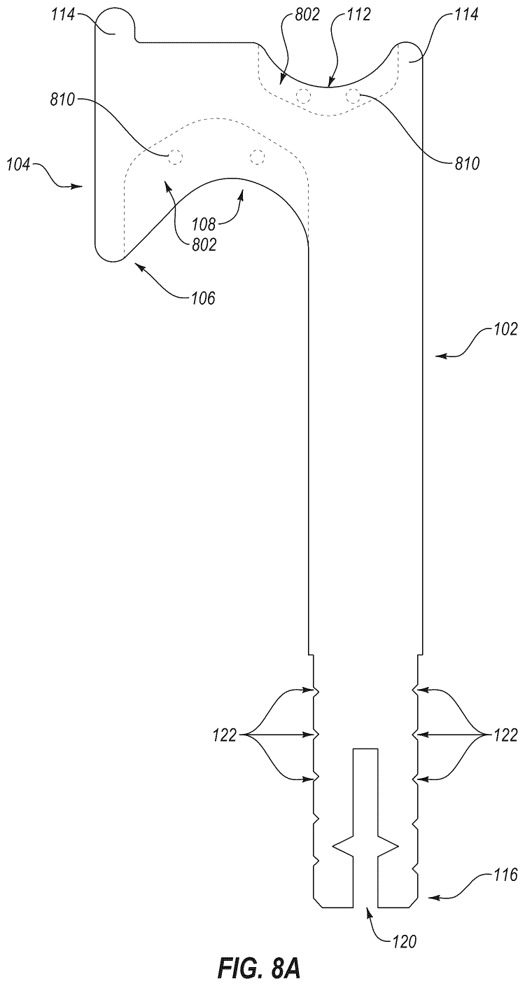

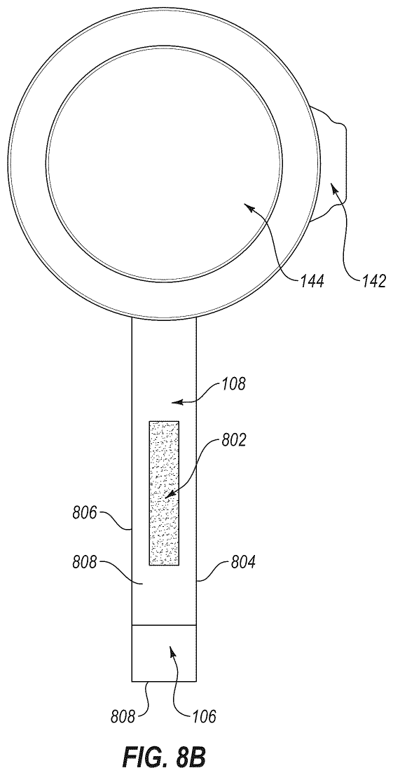

FIGS. 8A-8B illustrate the implant recess 802 that receives the brace implant. As such, the implant recess 802 can be shaped and dimensioned to receive any of the planar brace implants 702a-702f, or other shape. The implant recess 802 can be formed into the side surface 808 between the two planar surfaces 804, 806. FIG. 8A shows a side view where the cross-sectional profile of the implant recess 802 is shown. FIG. 8B includes a bottom view where the location of the implant recess 802 in the side surface 808 between the planar surfaces 804, 806 is shown.

The implant recess can be formed by any method. An example includes forming the head, and then forming the implant recess within the body of the head. For example, a carving device can be used to carve the material from the proximal concave region to form the implant recess between the two planar surfaces.

Further, in some embodiments, an end cap designed for use with a lightweight and durable railroad brake stick is provided. The end cap may allow a user to use the railroad brake stick in a practical manner including, for example, increasing the durability and balance of the lightweight railroad brake stick. Previously, railroad brake sticks are quite heavy and difficult for a user to transport and use, for example, as a walking stick or assist. Additionally, railroad brake sticks and end caps corresponding thereto may not be designed for heavy use as, for example, walking assist mechanisms and/or for storage on an end cap. As a result, when railroad brake sticks are stored on an end cap or used, for example, as a walking stick or assist, the railroad brake stick may begin to deteriorate.

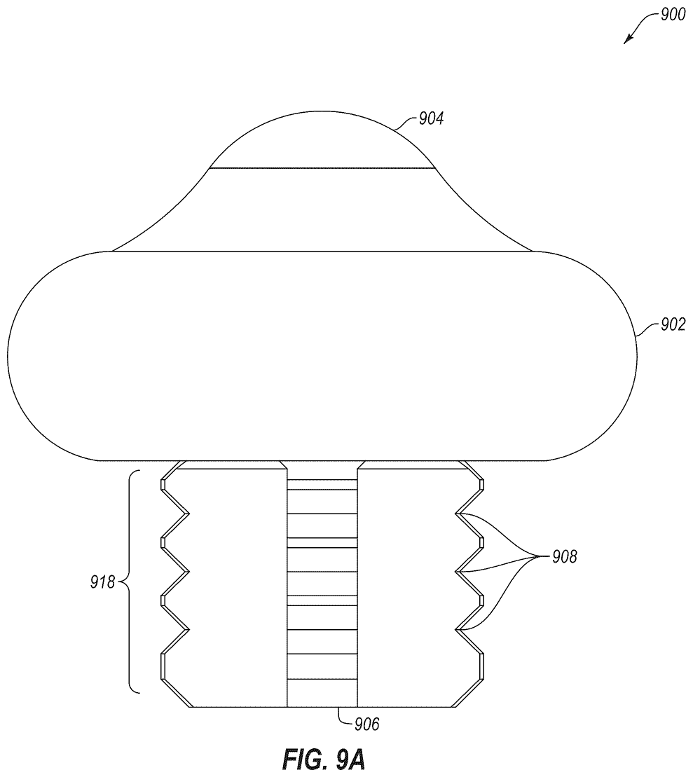

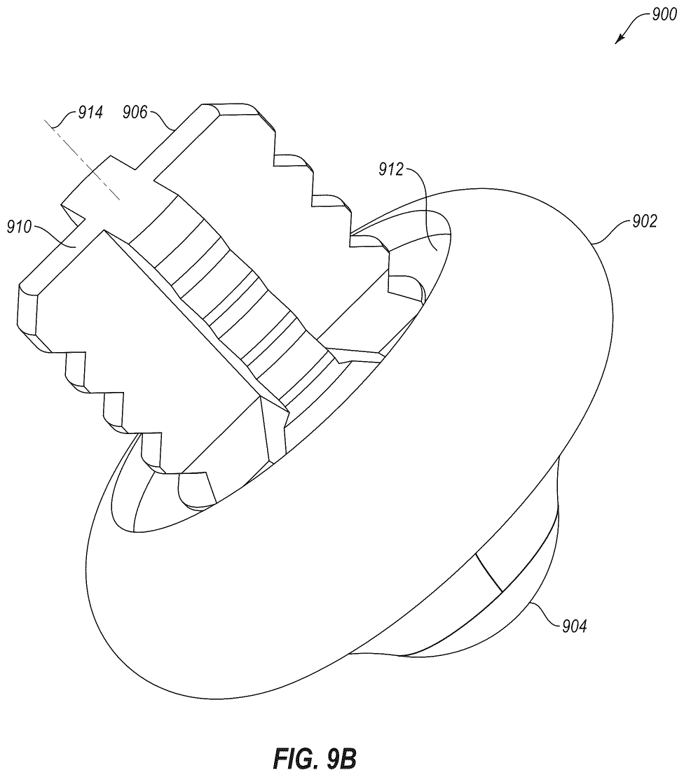

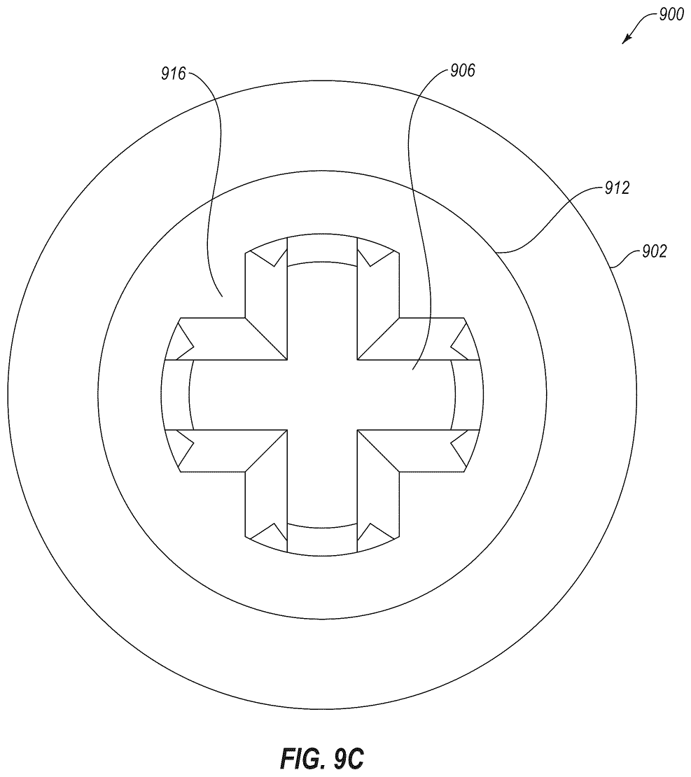

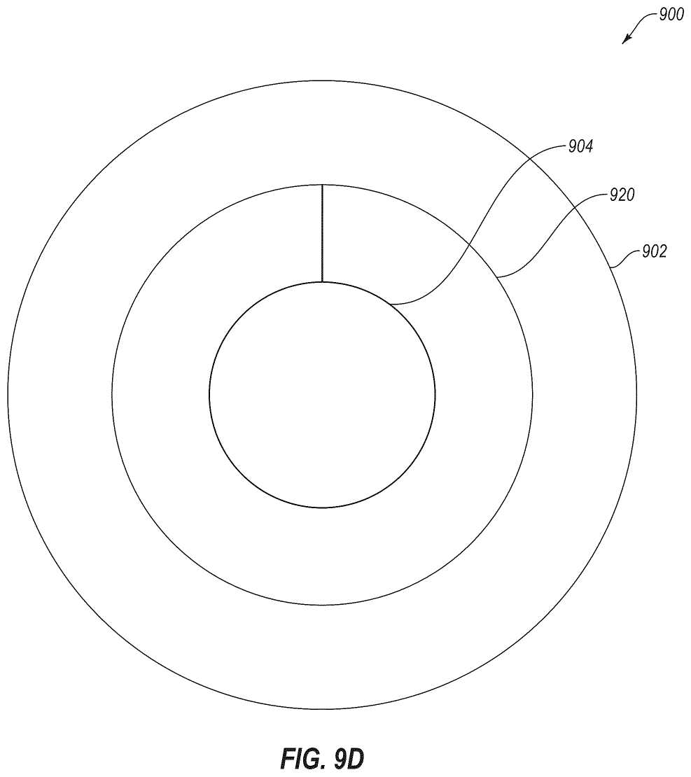

FIG. 9A shows a side view of the railroad brake stick end cap 900 arranged in accordance with at least one embodiment described in the present disclosure. The railroad brake stick end cap 900 may include a base 902 tapered to a nose 904. The railroad brake stick end cap may additionally include an engageable member 906 where the engageable member 906 may include one or more lateral sides 918. The one or more lateral sides may include one or more notches 908.

FIG. 9B shows perspective view of the railroad brake stick end cap 900 arranged in accordance with at least one embodiment described in the present disclosure. The railroad brake stick end cap 900 may include a base 902 with a circular or polygonal cross section tapering to a nose 904. The railroad stick end cap 900 may additionally include the engageable member 906 including three or more arms 910 that may intersect at a central axis region 914. The engageable member 906 may couple with the base 902 in a recess 912.

FIG. 9C shows a top view of the railroad brake stick end cap 900 arranged in accordance with at least one embodiment described in the present disclosure. The railroad brake stick end cap may include the engageable member 906, the recess 912, and the base 902. Additionally or alternatively, the railroad brake stick end cap 900 may include one or more chambers 916 between the three or more members.

FIG. 9D shows a bottom view of the railroad brake stick end cap 900 arranged in accordance with at least one embodiment described in the present disclosure. The end cap 900 may include a nose 904, a base 902 with a first circular or polygonal cross section, and the base 902 with a second circular or polygonal cross section 920 leading to a tapered cross section to the nose 904.

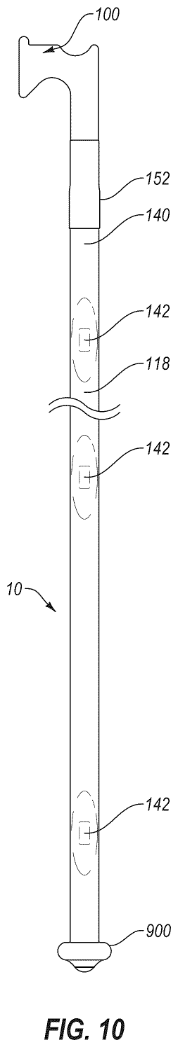

The figures show the end cap 900 having an outward facing portion including a base 902 that tapers to a nose 904 and an engageable member 906 configured to allow the end cap couple to a substantially hollow shaft such as, for example, the railroad brake stick 10 as described in and/or with respect to FIGS. 1-8 and/or FIG. 10 in the present disclosure.

In some embodiments, the figures show a base 902 that may have a circular cross section. In some embodiments, the base may have a polygonal cross section that may include a number of different shapes, sides, etc. such that the lateral dimension of the circular or polygonal cross section may be larger than a lateral dimension of the substantially hollow shaft (e.g., the railroad brake stick 10 and/or the handle 118).

In these and other embodiments, the base 902 may have a lateral dimension that may be wider than a lateral dimension of the engageable member 906. For example, a lateral dimension from one side of the base 902 to another side of the base 902 may be referred to as a first lateral dimension. Further, a lateral dimension of the engageable member 906 may include a measurement from one lateral side 918 of the engageable member 906 to a second lateral side 918 of the engageable member 906 and may be referred to as a second lateral dimension. Continuing the example, the first lateral dimension may be wider than the second lateral dimension.

In some embodiments, the base 902 may taper to the nose 904. In some embodiments, the base 902 may include the first circular or polygonal cross section that may taper to a second circular or polygonal cross section 920 that may taper to the nose 904. In some embodiments, a first taper from the first circular or polygonal cross section of the base 902 to the second circular or polygonal cross section 920 may be different than a second taper from the second circular or polygonal cross section 920 to the nose 904. In some embodiments, the nose 904 may be rounded. In some embodiments, the nose may be pointed and/or include a number of different polygonal cross sections. In these and other embodiments, the base 902 and the nose 904 may be configured in such a way that the railroad stick end cap 900 may be used as an end to a walking stick. For example, the base 902 tapering to the nose 904 may allow the nose 904 to dig into the ground to provide traction and the base 902 may provide stability while walking with the railroad brake stick (e.g., the railroad brake stick 10). In some embodiments, the railroad stick end cap 900 may be configured to couple to the railroad brake stick using the engageable member 906.

In some embodiments, an engageable member 906 may be vertically disposed extending away from the nose 904. In these and other embodiments, the distance between the nose 904 and the base 902 may be at least the distance from one end of the engageable member 906 coupled to the base 902 to a second end of the engageable member 906 extending away from the base 902. The length of the engageable member 906 may correlate to the level of stability and/or durability of the railroad stick end cap 900. For example, the engageable member 906 may have a length that may be at least as long as the length from the base 902 to the nose 904. Continuing the example, the engageable member 906 may be inserted in the handle 118 or another substantially hollow shaft such as, for example, described in FIG. 10 in the present disclosure. Further continuing the example, because the engageable member 906 has a length comparable to the length of the railroad stick end cap 900 remaining outside of the handle 118, the end cap 900 may be more stable and durable than the end cap 900 would be with an engageable member 906 with a shorter length than the length from the base 902 to the nose 904. Further, in some embodiments, an increase in a length of the engageable member 906 may include an increase in an amount of surface area that may be used to couple the railroad stick end cap 900 to the substantially hollow shaft (e.g., railroad brake stick 10 and/or the handle 118 as described in the present disclosure such as, for example, in FIG. 10) which may, in turn, increase the durability of the end cap 900 and/or the railroad brake stick 10 coupled to the end cap 900.

In some embodiments, the engageable member 906 may include three (3) or more arms 910 (e.g., 5 or 6 arms) that may intersect at the central axis region 914. Each of the three (3) or more arms 910 may include a respective lateral side 918 opposite the central axis region 914. The three (3) or more arms 910 may be spaced symmetrically, or in a substantially symmetric manner, around the central axis region 914. For example, the engageable member 906 may include three (3) arms, and the angle between each of the three (3) arms may be 120°. In another example, the engageable member 906 may include four (4) arms, the angle between each of the four (4) arms may be 90º.

In some embodiments, the three (3) or more arms 910 may each include a respective lateral side 918. In these and other embodiments, the respective lateral side 918 of each of the three (3) or more arms 910 may extend laterally away from the central axis region 914 a distance from the central axis region 914 that may be smaller than the distance that the base 902 extends laterally from the central axis region 914. In some embodiments, the lateral sides 918 for each of the respective three (3) or more arms 910 may additionally include one or more notches 908. In some embodiments, the one or more notches 908 on each of the lateral sides 918 may allow a binder to flow between the lateral sides 918 and the substantially hollow shaft when the engageable member 906 may be coupled with the substantially hollow shaft such as, for example, described in the present disclosure with respect to FIG. 10.

In some embodiments, the engageable member 906 may extend vertically upward from the base 902 where the base 902 may include a recess 912. In these and other embodiments, the recess 912 may be configured to receive a substantially hollow shaft such as, for example, the handle 118 described in the present disclosure with respect to FIGS. 1 and 10. For example, the engageable member 906 may be inserted into a substantially hollow shaft in such a way that one end of the substantially hollow shaft may touch or connect with the base 902 of the railroad stick end cap 900. In some embodiments, the engageable member 906 may extend into the substantially hollow shaft. In these and other embodiments, one or more chambers 916 may be formed between the three (3) or more arms 910 and an inner surface of the substantially hollow shaft.

In some embodiments, the one or more chambers 916 may help to facilitate a coupling of the railroad stick end cap 900 with a substantially hollow shaft by allowing a binder to come around and between the three (3) or more arms 910 of the engageable member 906 and the substantially hollow shaft. For example, the railroad stick end cap 900 may be coupled to and/or with a substantially hollow shaft by applying a binder around the engageable member 906 and/or inside the substantially hollow shaft. Continuing the example, the engageable member may be inserted into the substantially hollow shaft so that the binder may flow into each of the one or more chambers 916. Further continuing the example, the one or more notches 908 may allow the binder to flow into and between each of the chambers 916 prior to the binder setting that may allow the end cap 900 to adhere to the substantially hollow shaft.

FIG. 10 shows a side view of the railroad stick end cap 900 having the engageable member 906 inserted in the handle 118 arranged in accordance with at least one embodiment described in the present disclosure. The handle 118 may include one or more magnets 142 coupled to the outside of the handle 118. In some embodiments, the handle 118 may additionally include a handle sleeve 140. The handle 118 may additionally be coupled to a head 100 where the handle 118 may include a neck cover 152. In some embodiments, the handle 118 may be coupled to a railroad brake stick end cap 900. In these and other embodiments, the substantially hollow shaft discussed in FIGS. 9A-9D may include the handle 118 as illustrated in FIG. 10.

In some embodiments, a method of manufacturing a railroad brake stick 10 including an end cap 900 may be provided. The method of manufacturing a railroad brake stick may include, providing a head, the head including a planar shape with a proximal end, a distal end, a lower side, and an upper side. In some embodiments, the lower side of the head may include a curved recess and a protrusion on the distal end of the upper side of the head. In these and other embodiments, the head 100 may be configured to be substantially axe-shaped and may be configured to perform a number of operations that may be specific to a railroad brake stick. For example, the head 100 of the railroad brake stick 10 may be configured to operate railcar brake hand wheels. Continuing the example, the recess on the lower side of the head may be configured to connect and/or attach to the railcar brake hand wheel in a manner that may allow the user to pull the railroad brake stick and turn the railcar brake wheel. Further, using the railroad brake stick may allow the user to operate the railcar brake wheel in a safer manner that operating the railcar wheel by hand.

In some embodiments, the method of manufacturing the railroad brake stick may further include providing handle 118 including a first end and a second end. In some embodiments, the head 100 may be coupled to the first end of the handle 118. For example, the head 100 may be coupled to the handle 118 using a binder such as, for example, the binder described in FIGS. 5A-5C.

In some embodiments, the method may further include providing an end cap 900 where the end cap 900 includes an outward facing portion that may include a base with a circular cross section that may taper to a nose (e.g., the base 902 and the nose 904). Further, the end cap 900 may include an engageable member 906 that may protrude from the base opposite the nose 904. In some embodiments, the end cap 900 may be coupled to the second end of the handle 118 using a binder. In some embodiments, the binder used to couple the end cap 900 and the second end of the handle 118 may be the same binder as the binder used to couple the head and the first end of the substantially hollow shaft. In some embodiments, the binder may be different.

In some embodiments, the method of coupling the end cap 900 to the second end of the handle 118 may include applying the binder to the engageable member 906 of the end cap 900 and/or applying the binder to the inside of the second end of the handle 118. Further, in some embodiments, the engageable member 906 of the end cap 900 may be inserted into the second end of the handle 118 in such a way that the second end of the substantially hollow shaft may touch or connect with the base (e.g., base 902) of the end cap 900.

In some embodiments, the engageable member 906 may include three (3) or more arms 910 that may intersect at a central axis region 914. The three (3) or more arms 910 may allow chambers 916 to form between each of the three (3) or more arms 910 and the inside of the handle 118 when the engageable member 906 is inserted into the handle 118. The chambers 916 may be filled or partially filled with the binder that, when the binder sets, may allow the end cap 900 to couple to the handle 118.

In some embodiments, the lateral sides 918 of each of the three (3) or more arms 910 in the engageable member 906 may include one or more notches 908. In some embodiments, the one or more notches 908 may allow the binder to flow to and between each of the chambers 916 when inserted into the second end of the handle 118. In these and other embodiments, the one or more notches 908 may allow the binder to couple more of the surface area of the engageable member 906 to the inside of the handle 118 thereby increasing the strength of the coupling and the durability of the end cap 900 of the railroad brake stick 10.

In some embodiments, the method may include using the handle 118 or another substantially hollow shaft that may be wrapped in one or more layers of a composite material (e.g., Kevlar®). In these and other embodiments, the one or more layers of composite material may be folded from the outer surface of the handle 118 into the second end of the handle 118 prior to inserting the end cap 900 into the handle 118. In these and other embodiments, the one or more layers of composite material may be folded into the second end of the handle 118, a binder may then be used to couple the engageable member 906 to the handle 118 by inserting the engageable member 906 to the second end of the handle 118.

In some embodiments, the handle 118 may include one or more magnets 142 that may be coupled to the handle 118. In some embodiments, the one or more magnets 142 may be coupled to an outer surface of the handle 118. In some embodiments, the one or more magnets may be attached to a surface of the handle 118 and may then be wrapped in one or more layers of composite material. In some embodiments, the one or more magnets 142 may be used to attach the handle 118 for storage or to assist in using the handle 118 or the railroad brake stick 10.

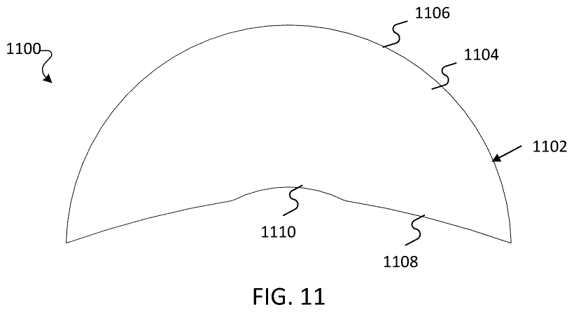

FIG. 11 illustrates another embodiment of an implant brace 1102 similar to those shown in FIG. 7. Additionally, implant brace 1102 includes a body 1104 defining two opposite planar surfaces and the perimeter surface 1106 therebetween, which perimeter surface 1106 includes a portion that operates as the working surface 1108 of the implant brace 1102. Here, the working surface 1108 includes a notch 1110 recessed therein. The notch 1110 provides an extra recess for guiding railroad equipment into the notch 1110 when working with the railroad brake stick, which can improve performance of railroad operations. In some embodiments, the implant brace can have a diameter of about 1.8 inches and a width of about 0.25 inches, which may be modified by up to about 1%, 5%, 10%, 25%, or 50%.

FIGS. 1B, 2B, 4A, 6, and 10 illustrate the magnets being mounted to the handle with the handle cover thereover, which allows for the taper of the handle to the magnet without hard edges. Now, a magnet brace can be used to retain the magnet therein and mount the magnet to the handle with tapered body surfaces, which provides for a smoother interface between the magnet and handle.

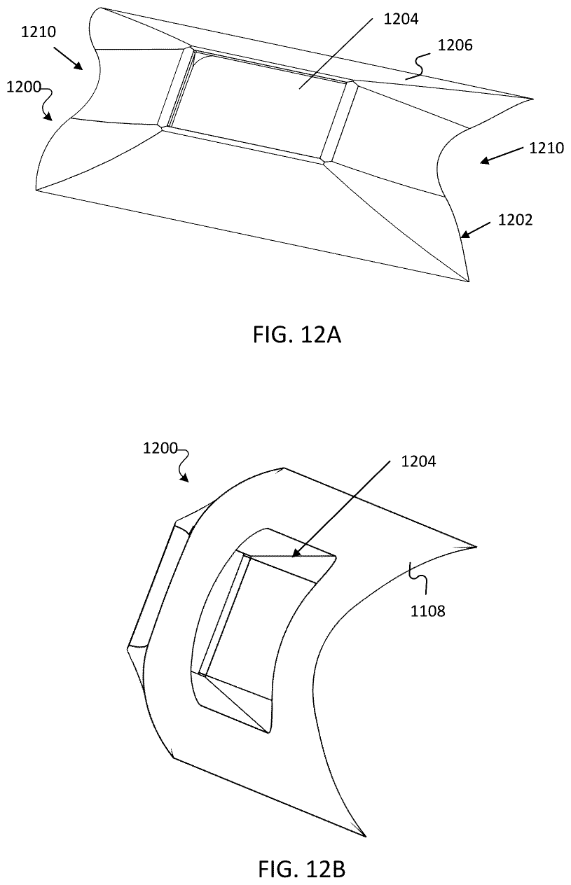

FIGS. 12A and 12B illustrate a magnet brace 1200 that is configured to receive a magnet and mount the magnet to the handle. As shown, rounded surfaces are used for the magnet brace 1200 to match the rounded surface of the cylindrical handle; however, flat or planar surfaces could be used for a squared handle. The magnet brace 1200 includes a body 1202 defining a magnet chamber 1204 that is shaped to match a magnet (e.g., shown rectangular, but can be circular, irregular or other shape). The magnet brace 1200 includes an external surface 1206 and rounded internal surface 1208 that matches a cylinder. The external surface 1206 can be sloped to provide an angular or smooth transition from the handle body to the top of the magnet. The ends 1210 can also be scalloped to match the cylindrical shape of the handle.

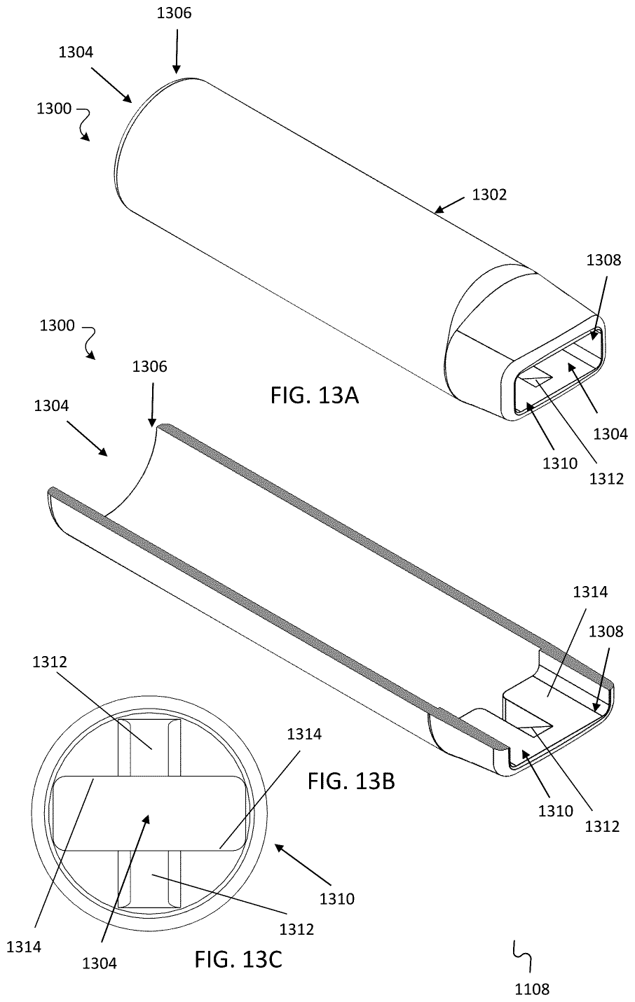

FIGS. 13A-13C illustrate a locking neck cover 1300, which is similar to neck cover 152 of FIGS. 2A-2B, configured into a shape-stable form, whether hard or elastomeric or rubber. By being in a shape-stable form, the locking neck cover 1300 can be molded or otherwise formed to have internal recesses that receive and mate with the interlocking region of the head and cross-support, which serve to lock the locking neck cover 1300 to the handle, cross-member, and head. The locking neck cover 1300 can include a body 1302 having an internal conduit 1304 from an open proximal end 1306 to a narrowed distal end 1308. The open proximal end 1306 can include a portion of the internal conduit 1304 that is shaped and dimensioned to be receive into the handle. The narrowed distal end 1308 is slot-shaped or rectangular to match the shape of the hilt of the head. The internal conduit 1304 includes a distal end region configured as a locking region 1310 by having recesses 1312 that mate with the cross-support when located therein. The locking region 1310 also includes hilt surfaces 1314 that are configured to receive and match with the hilt of the head. Therefore, the recesses 1312 mate with the cross-support and the hilt surfaces receive the hilt of the head, which forms an interlock of these members. Thus, the locking neck cover 1300 can lock the support member and head to the handle.

The railroad brake stick can have various configurations, such as those shown and described herein and the incorporated applications. In some embodiments, the head includes a top planar surface, bottom planar surface, and at least one short side surface extending between the planar surfaces. The side surface(s) cooperate to define the cross-sectional shape of the head, as shown in FIGS. 1A, 2A, 3B, and others. In some aspects, the side surface includes shapes formed therein to provide the head shape profile. In some aspects, the top surface and/or bottom surface can be flat or planar. In some aspects, the head is formed of a durable plastic, such as high density polyethylene, ultra-high molecular weight polyethylene, high density polyurethane, high density fluorinated plastics, polyamides (e.g., nylon, HyDLAR Z, nylon 6/6 with Kevlar® fibers filled plastics with enhanced abrasion resistance, etc.) or composite material. In some aspects, the head is formed from a plurality of layers of para-aramid synthetic fiber sheets (e.g., Kevlar®) laminated or bonded together. In some embodiments, the sides of the head include layers of Kevlar® that are exposed. However, the head may be a different material, such as other composites, high density plastics, etc. For example, the head can be a graphene composite material. In some aspects, the material of the head can be a plastic or composite described herein, which can include a filler, such as ceramic or composite fillers. An example includes Kevlar® fibers or ceramic particles being distributed through the body of the plastic.

In some embodiments, the cross-support is a plastic or composite material, which can be the same or different from the head. In some aspects, the cross-support includes a stop cut 127 (FIG. 3A), which abuts the end of the handle. The cross-support can be a layered carbon fiber material, layered para-aramid synthetic fiber, laminate material, composite material, or a polymer material. Alternatively, the cross-support is the durable plastic. In some examples, the cross-support can be any rigid material, such as a plastic, where acrylonitrile butadiene styrene (ABS) and polyurethane are examples. In some embodiments, the head is a abrasion resistant polymer (e.g., ultra-high molecular weight polyethylene) and cross-support is ABS. The cross-support may be thinner than the head.

In some embodiments, the handle includes carbon fiber. In some aspects, the handle is a tube of carbon fiber. However, other lightweight and durable materials can be used for the handle. The handle can be formed from a high density plastic, which can be different or the same as the head. Also, the handle may be formed from fiberglass, fiberglass with carbon fiber composite (e.g., fiberglass and carbon fiber layering), high density polyethylene, or other materials with high resistance to impact.

In some embodiments, a handle sleeve is a cover that is on the handle. In some aspects, the handle sleeve also covers a proximal portion of the head. In some aspects, the handle sleeve includes carbon fiber. In some aspects, the handle sleeve includes carbon fiber woven with a colored material, the colored material being a color other than black. In some aspects, the handle sleeve is a woven carbon fiber, woven fiberglass, Kevlar® (aramid), or combinations thereof. Alternatively, the sleeve can be other shrink tubing that can be shrink-fit onto the handle. Alternative materials include polyolefins, polyvinyl chloride, hydrofluorocarbons, elastomers, or others.

In some embodiments, a neck cover over a portion of the handle sleeve adjacent to the head and continuing over a portion of the head. The neck cover can be a shrink tube shrunken onto the handle and proximal portion of the head. The neck cover can be polyurethane, which is configured as a heat shrink plastic. However, rubber, elastomer, or other protective materials could be used to protect the junction of the handle and head.

In some embodiments, the neck cover is a hard member with a defined shape. The hard neck cover can be prepared out of various materials and shaped to fit onto the handle over the interlocking region of the head and cross-support. The hard neck cover can be molded to define the outer surface and internal lumen and shapes formed therein. The hard neck can include an internal conduit that is shaped to be received over and match with the hilt of the head and the cross-support at the interlocking region, such that the interlocking shape is fit into the corresponding interlocking recess or grooves in the internal conduit of the hard neck cover.

In some embodiment, the brake stick includes at least one magnet on the handle. In some aspects, the at least one magnet is between the handle tube and handle sleeve covering. In some aspects, the handle includes at least two magnets, where the at least two magnets are spaced apart from each other. In some aspects, the handle includes at least three magnets spaced apart from each other, where two of them can be closer to each other (e.g., near head) and one near the proximal end (e.g., opposite of the head).

In some embodiments, the brake stick is less than 3.5 lbs (and some weigh greater than 1.5 lbs). This can be achieved with composite materials (e.g., Kevlar® layers). Kevlar® is a heat-resistant para-aramid synthetic fiber with a molecular structure of many inter-chain bonds that make Kevlar® incredibly strong. Best known for its use in ballistic body armor, Kevlar® also has many other applications because of its high tensile strength-to-weight ratio. The chemical structure of Kevlar® is comprised of several repeating inter-chain bonds. These chains are cross-linked with hydrogen bonds, providing a tensile strength 10× greater than steel on an equal weight basis. In some aspect, the brake stick is less than 3.5 lbs when about 5 foot long. This translates to about 3.5 lbs per 5 ft. In some aspects, the brake stick is devoid of a metallic material on the head and/or handle. In some aspects, the Kevlar® is substituted with a different composite layering material. In some aspects, the head is a bulk composite material (not layered). While the length of the brake stick can determine the weight, the sizing or length can be configured to provide a brake stick that is less than or about 3.25 lbs, less than or about 3 lbs, less than or about 2.5 lbs, less than or about 2 lbs, less than or about 2.2 lbs, less than or about 2.5 lbs, less than or about 2.75 lbs, and less than or about 3 lbs (and greater than 1.5 lbs).

In some examples, the length of the brake stick can determine the weight as follows: 75″ long tool weighing in an average of 2.5 lbs; 67″ long tool weighing in an average of 2.3 lbs; 48″ long tool weighing in an average of 2.0 lbs; or 37″ long tool weighing in an average of 1.8 lbs.

In some embodiments, the handle has a crush strength of at least 2000 lbf, such as 2,136 lbf to 2,528 lbf to 2,674 lbf. The head has a tensile strength of at least 2000 lbf, such as 2,815 lbf to 3,120 lbf. The rubber handle end cap can be pulled off at about 1000 lbf to 1,230 lbf.

In some embodiments, the head has as shape as shown in one of the figures or incorporated references or provisional application.

In some embodiments, a method of manufacturing the railroad brake stick of one of the embodiments is provided. The manufacturing method can include: providing the head; providing the cross-support; interlocking the head and cross-support via the slots thereof in a tongue and groove interlocking; providing the handle; inserting a binder into a distal portion of the handle; inserting the interlocked head and cross-support into the distal portion of the handle or into binder in the distal portion of the handle; and curing the binder to fix the head in the handle. The head and cross-support can be inserted into the handle before the binder is applied or after the binder is applied. Also, the cross-support can be inserted into the handle before being coupled with the head.

The brake stick has a composite handle that also attributes to the lightweight. The head has the shaping for manipulation of the railroad environment.

In some embodiments, the head is made out of layers of Kevlar® (e.g., layered para-aramid synthetic fiber) that are stacked together and then cut to have the desired shape. In the process of preparing the head of the brake stick, the different layers of Kevlar® are manipulated as known for pressing Kevlar® layers together, which can be about 30 to 40 layers; however, this can vary depending on the desired thickness of the head. The number of Kevlar® layers could range or vary to change the thickness of the head, but in any event, no matter what the thickness is, it needs to be within certain dimension parameters. The thickness of the head can be between the 1 inch to 2 inch range, but that could vary. Other layered composites may also be used. For example, a graphene composite material can be layered and used for the head. Alternatively, durable high density plastics can be used for the head. In some aspects, the durable high density plastics can include fillers that improve durability, such as glass particle fillers or ceramic particle fillers or metal particle fillers.

The head is cut out and then the proximal portion has a slot that is cut out of the head. A brace or cross-support member that is made of the same material or different material that has a corresponding slot is provided. The head and cross-support member have the corresponding slots so manufacturing can interlock them together in a somewhat tongue and groove fashion where they are slid into each other. The coupling causes the cross-section of the head to have a plus sign shape. So, the plus sign shape has each arm of the plus being a body of the head the cross-support. Those head and cross-support together create a hilt of the head.

The head includes the cross-sectional plus shape when combined with the cross-support. The edges of the exposed head and cross-support (e.g., not on the flat surface of the planar bodies) that are the cut edges of the head include recesses or notch shapes cut into it at the interlocking region. The recesses or notches allow for the further processing to attach the head to the handle with better adhesion. The notches provide improved grip between head and handle. The head and cross-support each includes the notch features etched into or cut into the sides (e.g., not the flat surface but the cut surface of the head) so the head that has the two pieces stuck together with a plus shape cross-section that has the notches on the four arms of the head and cross-support member.

The cross-support includes a tapered distal end that tapers from the handle to the rest of the head, the angle can be 40-60 degrees or other. This can be cut into the material that forms the cross-support. The shape is shown in the figures.

A long handle is provided, which can be a cylindrical handle in the form of a tube. On the distal end of the tube where the head is going to be received, there can be an opening to an internal lumen in the handle. The lumen can be within the tube and extend all the way from one end to the other end in order to provide the lightweight to the railroad stick. While the shapes are shown for the handle to be a circular cross-sectional tube, other shapes, such as polygons (e.g., square) could also be used.

The head that has the hilt with the cross-support to form the plus shape includes the interlocking region having cut outs or notches on the exposed edges of the cut edges. The interlocking region is slid into the handle end, and then epoxy, or another binding material is inserted into the handle and it cures around the cross sectional plus shape as well as through notches on the head and cross-support to create a more solid bond with the head and handle. However, the binder may be placed in the tube prior to the interlocking region of the head. In some aspects, the cutouts can match smaller grooves inside the tube, which may be aligned with the cut outs or random. The binder goes into the notches and binds the tube so it creates kind of a lock.

In some aspects, manufacturing includes sanding and roughening the inside of the handle tube so it adheres better to the epoxy and flox of the binder. The inside of the handle tube can be randomly sanded so the internal surface is grooved like a record album. The epoxy will be able to go between the notches and the sanded inside surface of the tube for better binding.

In some aspects, the epoxy includes a flox, which is a mixture of a flocked cotton that is mixed with the epoxy. The epoxy with flocked cotton “flox” makes a strong coupling because the fibers lock in together. The fibers help lock against the grooves sanded inside as well as the notches that are cut into the interlocking region of the head and cross-support. However, other binders or epoxies can be used. The epoxy may be used with or without filler. The filler may be cotton, fiberglass, or other filler.

During manufacturing, the plus shaped cross section of the hilt allows the product to have the epoxy in the four quadrants. The epoxy is provided to extend between quadrants through the notches to make a tighter lock with the handle. Also, the binder can penetrate into the sanded imperfections to make a tighter grip with the inside of the head. In an example, a caulking gun can be used to fill the chambers with the epoxy; however, other insertion methods can be used to provide the binder. In some aspects, the epoxy is only in the region in the lumen of the tube and hilt.

During the manufacturing process, there can be a dowel or an elongate member that can be inserted into the proximal end of the tube to provide a stop for not allowing the epoxy to move past it during the manufacturing procedure. In some aspects, a material is used as a plug. The plug is placed in as deep as desired and the other end of the tube has a tube inserted temporarily to hold it in while pushing in the epoxy into the top distal opening of the tube. The plug can be a wad of material or a flat disc, cylinder, or other shape of a material resistant to the binder. The binder can be an epoxy that is placed into the tube above the plug so it is retained at the distal end, and then the head is inserted into the epoxy in the distal end of the tube. Alternatively, the head is inserted into the handle, and then the epoxy is added. The plug can be paper, cotton, or other material that functions as a stop for stopping the flow of epoxy or flox. The plug can be retained in the device, or pulled out after the epoxy cures. The plug can be any material stop inside the handle that prevents the epoxy from going all the way through the lumen and filling up the handle. For example, a small piece of paper is used so that the dowel will then pull back out and that piece of paper becomes part of the epoxy. A stopping material that stops the epoxy from moving any further is positioned somewhat relative to the proximal end of the hilt of that head. Alternatively, a material that epoxy doesn't stick to can be used as a temporary plug if desired. The dowel can be a material that does not stick to the epoxy.

In an example, the process can include putting the dowel in, putting the plug stop against the dowel, then filling (e.g., to some extent, not completely, but partially) the head end of the handle with the epoxy flox cotton mix. The head can then be pushed into the epoxy into it until it bottoms out. The epoxy is again applied until it oozes enough out then it is tapered off to the handle. Twisting can enhance filing of the notches with the epoxy.

In some aspects, the notches of the head and cross-support are filled with epoxy prior to insertion into the handle. In some aspects, the surfaces of the hilt are coated with epoxy prior to insertion into the handle. Alternatively, the hilt can be clean prior to insertion into the epoxy that is located in the distal end of the handle. The procedure can remove air pockets from the epoxy or from inside the handle around the hilt of the head.

In some embodiments, the pieces of the head assembly that is inserted into the tube handle are cut such that they will only go so far into the tube. There is a stop cut 127 (See. FIG. 3A) that hits the outside of the tube. That's how it is known when the head is fully inserted.

In some embodiments, the method can include applying binder to the notches of the head and/or cross-support. This can be performed at the same time the binder is applied into the handle. However, the interlocking region and notches can be preloaded with the binder.

In some embodiments, the method can include fitting a handle sleeve as a cover over the handle and optionally over a portion of the head or optionally tucked down into the internal conduit ends of the internal conduit of the handle. In some aspects, the method includes binding the handle sleeve to the handle. In some aspects, the binder is applied to the handle prior to applying the handle sleeve to the binder on the handle. In some aspects, the binder is epoxy. In some aspects, the binder includes structural reinforcement fibers. In some aspects, the binder structural reinforcement fibers include cotton. In some aspects, the binder for the handle sleeve can be devoid of cotton fiber or other fillers.

In some embodiments, a coating or tube or layer or sheet is applied over the handle as the handle sleeve. Optionally, the handle sleeve extends over a portion of the hilt of the head or is tucked into the internal conduit ends of the handle around the interlocking region of the head and cross-support. The handle sleeve can be a composite, such as carbon fiber or Kevlar® with or without another material, such as fiber glass. In some aspects, the handle sleeve is not just carbon fiber, but can be a mix of half the threads are carbon fiber, the other half is a weave. For example, the handle sleeve can be configured like a sock of carbon fiber and/or Kevlar® with or without woven fiber glass.

In some embodiments, the weave material can be colored. For example, the handle sleeve can be a weave of just carbon fiber, which would only be black carbon fiber, and fiber glass, the color being the fiber glass. Alternatively, the handle sleeve can be carbon fiber with or without Kevlar®, or vice versa. The color can be monochromatic or multichromatic. It can be advantageous to include a secondary color in the handle sleeve for visual purposes, such as identifying the location of the tool and make it easier to see. The color can help for identifying and locating the tool (e.g., for safety reasons). Traditional carbon fiber or tubular Kevlar® processing can be used to put the handle sleeve around the handle and then seal it against the head and the handle with binder. The handle sleeve can cover the distal opening of the handle. Using epoxy on the handle sleeve to bind it to the handle can provide a nice smooth finish. In some aspects, it is a grippy finish.

The brake stick can have a transition from the handle to the head to provide an outer protective layer, such as the carbon fiber, Kevlar®, fiberglass, or other protective layer cover. This process can include putting epoxy on the tubular handle, put the handle sleeve on the handle, putting epoxy on the sleeve, and then rubbing the binder off. The hard neck cover can cover the transition from the handle to the head and provide for internal grooves that correspond and receive the hilt and cross-support of the interlocking region.

In some aspects, the method can include: put epoxy on the head or on the handle first partway down the head, then slide the handle sleeve on the handle, rub the epoxy in, put more epoxy on the outside, and then wipe the handle sleeve down with alcohol so that the handle does not have slicky epoxy on the outside. The bottom of the handle sleeve is tucked up in the proximal opening of the handle, optionally, the handle sleeve is tucked into the distal opening of the handle. The protocol can include tucking the extra handle sleeve up in the bottom portion (e.g., proximal end or distal portion) of the tubular handle so the handle sleeve wraps around the corner and tucks up in, or cutting off the excess. Optionally, a dye, such as a yellow or other visible colorant, can be added to the epoxy to enhance the color of the sleeve to be more visually noticeable for safety and visibility purposes.

In some embodiments, the method includes fitting a neck cover, such as either hard or soft) over a distal portion of the handle sleeve and a proximal portion of the head. In some aspects, the method includes shrink wrapping the neck cover over portions of the handle sleeve and head. In some aspects, the neck cover is a shrink tube, and is epoxied to the handle by: putting some epoxy on the handle itself, putting the shrink tube over it, and applying heat to shrink it in place. In some aspects, the neck cover is a hard neck cover formed of a durable plastic, which can be the same or different from the material of the head. The hard neck cover can be fit over the handle and the interlocking region.

In some embodiments, a method of manufacturing includes: inserting cross-support into opening in hollow handle until laterally protruding stops are received onto the lip of the opening; sliding the hard neck cover over the handle and cross-support until the cross-support is received into support recesses formed into internal surfaces of the hard neck cover; and sliding the hilt of the head into the internal conduit of the hard neck cover until the slot of the hilt interlocks with the slot of the cross-support to form the interlocking region within the internal conduit of the hard neck cover and handle.

In some embodiments, the method can include adhering at least one magnet to the handle prior to applying the cover to the handle and magnets. The adhering can be by superglue (cyanoacrylate) or epoxy, or flox, or other adherent. The magnets can include the adherent built up around the sides of the magnet to round out the edges and build up the material around the magnet, but not on the side facing outward from the handle. The outward facing side is only covered with the handle sleeve. In some aspects, at least one magnet is coupled to the handle within the handle sleeve. The magnet(s) can be used to attach the brake stick to metal commonly found in railroad settings. There may be one magnet, but two magnets can be useful to retain the stick in place. In some aspects, the magnets are placed strategically for magnetically attaching the brake stick on a train or a door or ferromagnetic surface. In some aspects, manufacturing attaches two or more magnets to the side of the stick on the flat side or corresponding side orthogonal with the plane of the head. One example includes two magnets spaced apart to be distal or near the head and at least one magnet medial or proximal to the proximal end of the handle.

In some embodiments, another feature of the magnet is that it gives a grip that is a wider region, so the user can get a little better grip from it because the magnet is flat on the outer part of the stick. In some manufacturing, a sleeving is over the magnets and epoxied down.

In some embodiments, the method can include manufacturing at least one of: the head; the cross-support; or the handle. In some aspects, the method can include preparing a plastic or multi-layered composite head and/or cross-support. In some aspects, the method can include cutting the head and/or cross-support from a sheet of plastic or composite material.

In some embodiments, the method can include fitting the end cap onto a proximal end of the handle. In some aspects, the end cap is adhered to the proximal end of the handle opposite of the head. The end cap can be rubber. The end cap can be epoxied onto the handle.

In some embodiments, the end cap has some type of hook or some type of attachment means (e.g., aperture, fastener, etc.) in order to be able to hook or otherwise fasten it onto something.

In some embodiments, there can be drill holes in the head. In the railroad environment, there can be apertures in the stick head that can be used to hang it over hooks. Manufacturing can put holes in it to decrease the weight but still retain the structural integrity.

The brake stick can be significantly strong. The brake stick can have a tensile strength of between 2,474 lbs in one case and 2,629 lbs in another to bends or breaks. However, the tensile strength before catastrophic failure can be greater than or about 200 lbs, greater than or about 300 lbs, greater than or about 400 lbs, greater than or about 500 lbs, greater than or about 600 lbs, greater than or about 700 lbs, greater than or about 800 lbs, greater than or about 1000 lbs, greater than or about 1250 lbs, greater than or about 1500 lbs, greater than or about 1750 lbs, or greater than or about 2000 lbs.

In some embodiments, minimum constant can have a tensile strength of at least or about 800 lbs. The bottom cap will pull off at about 1200 lbs. For example, the lateral crush test is 2,700 lbs.

In some examples, the handle can be at least or about 1 foot, at least or about 2 feet, at least or about 3 feet, at least or about 4 feet, at least or about 5 feet, at least or about 6 feet, or longer if needed.

In some embodiments, a method of using a railroad brake stick is provided. The method can include: providing the railroad brake stick of one of the embodiments; and using the railroad brake stick in a railroad environment. In some aspects, the method can include: using the railroad brake stick for: push or pull brake wheel; push brake release lever; turn angle cocks; adjust draw bars; and/or operate and arm EOTS.

In some embodiments, the manufacturing method of attaching a head to a handle can work for garden tools, docking stick for boats, non-conductive sticks for electrical work, or the like. In some embodiments, the method of manufacture described herein is for manufacturing a tool other than a brake stick. That is, the resulting tool can be a hockey stick, golf putter, yard tool, garden tool, or any other tool that has a head and cross-support in a tubular handle, optionally coated with or without magnets.

In some embodiments, a railroad brake stick can include: a head having a planar shape with a recess and/or protrusion on one or more side surfaces of the planar shape, the planar shape having a head interlocking groove on a hilt region; a cross-support having a planar shape with a support interlocking groove interlocked with the head interlocking groove such that the planar shape of the head crosses with the planar shape of the cross-support to form an interlocking region; and a handle coupled to the head and cross-support such that the interlocking region is within an end of the handle. In some aspects, a handle sleeve is over the handle. In some aspects, the handle sleeve continues over a portion of the head. In some aspects, the head is a durable plastic or composite material and the cross-support is also a durable plastic or composite material, and the handle is a composite material. In some aspects, the head is a durable plastic or first composite material, the cross-support is the durable plastic or first composite material or a different second composite material, the handle is a third composite material and the handle sleeve is a fourth composite material. In some aspects, the durable plastic is high density polyethylene, high density polyurethane, high molecular weight plastic (1-3 million Da), ultra-high molecular weight plastic (3-7.5 million Da), whether filled (e.g., ceramic particles, Kevlar fibers, etc), or other material. In some aspects, the first composite material includes a para-aramid synthetic fiber or a graphene composite material (e.g., graphene in a matrix, such as a binder), or combinations thereof. In some aspects, the second composite material is a layered carbon fiber material, layered para-aramid synthetic fiber, laminate material, composite material, or substituted with a polymer material. In some aspects, the third composite material is carbon fiber. In some aspects, the fourth composite material is woven carbon fiber, woven fiberglass, para-aramid synthetic fiber tube, polyolefin, polyvinyl chloride, fluorohydrocarbon, elastomer, Kevlar (aramid), or combinations thereof. In some aspects, at least two magnets are located on the handle spaced apart from each other.

In some embodiments, the head and handle as well as the handle sleeve of the railroad brake stick are each prepared from non-metallic materials. For example, the head, handle, and/or handle sleeve may each be made of non-metallic materials including one or more of woven carbon fiber, woven fiberglass, para-aramid synthetic fiber tube, polyolefin, polyvinyl chloride, fluorohydrocarbon, elastomer, Kevlar (aramid), or combinations thereof. As a result, the railroad brake stick is devoid of any exposed metallic materials, thereby providing a non-sparking embodiment. While the magnet may be metallic, the magnet is covered by the handle sleeve so that it is not exposed and cannot spark. The non-metallic or non-sparking embodiment with no exposed sparking metal can be used in environments where sparking can be catastrophic. While banging metal railroad brake sticks can cause sparking, the non-sparking embodiment without any exposed metal provided by the composite material allows for use in environments where sparking should be avoided. This allows the composite railroad brake stick to be used in mines, in oil production and refinery sites, in volatile environments, and in product loading areas at production facilities.

In some embodiments, a method of manufacturing a railroad brake stick can include: providing a head having a head interlocking groove on a hilt region; providing a cross-support having a support interlocking groove; interlocking the head and cross-support via the head interlocking groove and the support interlocking groove being coupled in a tongue and groove interlocking; providing a handle having a recess in a distal portion of the handle; inserting the interlocked head and cross-support into the distal portion of the handle; and fixing the handle to the interlocked head and cross-support. In some aspects, the method can include: providing a binder; and binding the handle to the interlocked head and cross-support with the binder. In some embodiments, the binder is epoxy. In some embodiments, the binder includes structural reinforcement fibers. In some aspects, the method can include fitting a handle sleeve as a cover over the handle, and then binding the handle sleeve to the handle. In some embodiments, the binder for the handle sleeve is epoxy. In some embodiments, the binder for the handle sleeve does not include structural reinforcement fibers.

In some embodiments, a method of using a railroad brake stick can include: providing the railroad brake stick of one of the embodiments; and using the railroad brake stick in a railroad environment. In some aspects, the method can include using the railroad brake stick to: push or pull brake wheel; push brake release lever; turn angle cocks; adjust draw bars; and/or operate and arm EOTS.

### EMBODIMENTS

In some embodiments, a railroad brake stick head can include: a planar head body having two opposing planar surfaces spaced apart by at least one sidewall that includes at least one concave sidewall region, wherein the head body is formed of a first material having a first hardness; and at least one brace implant at least partially embedded or located in at least one concave sidewall region, wherein each brace implant is formed of a second material having a second hardness that is harder than the first hardness. In some aspects, at least a portion of each brace implant protrudes from the respective concave sidewall region, which dimension of protrusion from the surface of the concave sidewall region to the corresponding surface of the brace implant (e.g., parallel working surface, such as proximal or distal) In some aspects, the head body includes at least one implant recess formed into the at least one concave sidewall region, and the at least one brace implant is in the at least one implant recess. In some aspects, each brace implant is coupled with the head body. In some aspects, the coupling of each brace implant with the head body is by friction fit, adhesive, fastener, or combination thereof. In some aspects, the fastener includes at least one rivet or other member (e.g., roll pin) that rivets or otherwise couples to the brace implant through the planar surfaces of the head body.

In some embodiments, the head body is formed of a plastic material or a composite material. In some aspects, the plastic material is selected from high density polyethylene, ultra-high molecular weight polyethylene (UHMW-PE; 3.5-7.5 million Da), high density polyurethane, polyoxymethylene (Acetal), polyimide (Vespel), high impact polystyrene, polyamide (nylon), polyamide-imide (PAI), polybutylene terephthalate (PTB), polyetheretheketone (PEEK), polyethylene terephthalate (PET), or combinations thereof. The head body material may also include filler, such as ceramic particles, Kevlar fibers or other particles/fibers, which can increase the abrasion resistance. The polymer can be impregnated with the filler to achieve tough inert very abrasive resistant (TIVAR) plastics, such as TIVAR UHMW plastics (e.g., TIVAR UHMW-PE). TIVAR is available in unfilled and filled grades for enhanced wear resistance, UV resistance, ESD, lower COF, higher operating temp, flame retardant and other enhanced properties.

In some embodiments, the brace implant is formed of a metal material. In some aspects, the metal material is selected from brass, stainless steel, carbon and manganese steels, bronze, manganese bronze (e.g., manganese bronze 865), or combinations thereof. In some aspects, the brace implant is a non-sparking material. In some aspects, the non-sparking material is cubic boron nitride, carbon nitride, carbide, cermet, brass, bronze, manganese bronze (e.g., manganese bronze 865), copper-nickel alloy, copper-aluminum bronze alloy, copper-beryllium bronze alloys, or combinations thereof.

In some embodiments, the head body includes a head portion and a hilt portion, wherein the hilt portion includes a slot extending between the two opposing planar surfaces from a hilt end toward the head portion. In some aspects, the hilt portion includes at least one notch formed into at least one hilt sidewall, wherein each notch extends between the two opposing planar surfaces. In some aspects, the slot includes at least one notch formed into at least one slot sidewall, wherein each notch extends between the two opposing planar surfaces.

In some embodiments, a railroad brake stick can include the railroad brake stick head of one of the embodiments and a handle coupled with the railroad brake stick head. In some aspects, the railroad brake stick can include: the head body having a planar shape with a head interlocking groove on a hilt region; a cross-support having a planar shape with a support interlocking groove interlocked with the head interlocking groove such that the planar shape of the head crosses with the planar shape of the cross-support to form an interlocking region; and the handle is coupled to the head and cross-support such that the interlocking region is within an end of the handle.

In some embodiments, the railroad brake stick can include at least one of a phosphorescent member or reflective member attached to the handle.

In some embodiments, a method of making the railroad brake stick head can include: forming a head body having two opposing planar surfaces spaced apart by at least one sidewall that includes at least one concave sidewall region, wherein the head body is formed of a first material having a first hardness; forming at least one brace implant; and embedding the at least one brace implant in at least one concave sidewall region, wherein each brace implant is formed of a second material having a second hardness that is harder than the first hardness. The embedding can result with at least a portion of the brace implant being exposed and protruding from the surface of the respective concave sidewall.

In some embodiments, a method of making a railroad brake stick can include performing the method to obtain the railroad brake stick head; and coupling the railroad brake stick head with a handle.

In some embodiments, a method of operating a railroad brake stick can include providing the railroad brake stick of one of the embodiments, and operating a railroad element with the head of the railroad brake stick such that at least one brace implant contacts the railroad element.

In some embodiments, a railroad brake stick may include the railroad brake stick head made of non-metal material. Additionally, the head may include a planar shape with a proximal end, a distal end, a lower side, and an upper side. Additionally or alternatively, the lower side may include a curved recess and the upper side on the distal end of the head that may include a protrusion. Further, the railroad brake stick may include a substantially hollow shaft made of and/or including a composite material (e.g., carbon fiber) where the substantially hollow shaft includes a first end and a second end. The first end may be coupled to the proximal end of the head of the railroad brake stick. Additionally, at least one magnet may be coupled to the substantially hollow shaft, and an end cap may be coupled to the second end of the substantially hollow shaft. Additionally, a portion of the end cap may be configured to be inserted into the second end of the substantially hollow shaft. The end cap may be coupled to the proximal end of the substantially hollow shaft using a binder (e.g., an epoxy and/or a flox).

In some embodiments, the railroad brake stick can include: a head including a planar body with a working region having a perimeter head shape with at least one working surface and with a hilt region having a hilt slot; a brace implant that is received into an implant slot formed into the working surface of the planar body of the head, wherein the brace implant is made of a material that is harder than a material of the head, wherein the brace implant includes a concave working surface that exposed from the head, wherein the concave working surface has a notch formed therein; a cross-support including a planar body with a support slot that mates with the hilt slot to form an interlocking coupling; an elongate handle with a substantially hollow shaft having a first end and a second end, the first end having a first opening receiving the hilt region and cross-support to have the interlocking coupling located within a lumen of the hollow shaft; a binder in contact with the lumen of the hollow shaft and in contact with the hilt region and cross-support so as to couple the hilt region and cross-support to the lumen of the hollow shaft; a handle cover over the elongate handle, wherein the elongate handle cover is a woven fiber, wherein a portion the handle cover extends over the second end of the hollow shaft and is tucked into the second end of the lumen, and a second binder binds the neck region to the portion of the handle cover within the lumen of the handle, wherein a portion the handle cover extends over the first end of the hollow shaft and is tucked into the first end of the lumen; at least one magnet coupled to the elongate handle and covered by the handle cover, a magnet brace for each magnet, each magnet brace having a magnet chamber retaining a respective magnet therein, the magnet brace having an internal surface with a contour that matches a contour of the elongate handle, wherein the magnet brace is covered by the handle cover; a hard neck cover having a conduit extending from an open tapered neck to an open end, the open tapered neck receiving the hilt region therethrough so as to retain the interlocking coupling withing within the conduit, wherein the conduit at the open tapered neck has opposing surfaces that braced respective hilt surfaces and recesses formed into the opposing surfaces that receive the cross-support; and an end cap coupled to the second end of the elongate handle, wherein a neck region of the end cap is configured with a plurality of support wings that define regions to retain the second binder and is inserted into the second end of the hollow shaft, and a second binder is in contact with the lumen of the hollow shaft in contact with the neck region so as to couple the neck region to the lumen of the hollow shaft, wherein the binder and second binder are the same or different.

In some embodiments, the railroad brake stick can include at least one of a light reflective member or a phosphorescent member coupled with at least one of the head, hard neck cover, or handle cover.

In some embodiments, the handle cover includes a color at least one of red, pink orange, green, or yellow coloring, whether fluorescent, phosphorescent or non-florescent.

In some embodiments, the head is a material selected from high density polyethylene, ultra-high molecular weight polyethylene, high density polyurethane, high density fluorinated plastics, polyoxymethylene, polyimide, high impact polystyrene, polyamide, polyamide-imide, polybutylene terephthalate, polyetheretheketone, polyethylene terephthalate, layered para-aramid synthetic fiber sheets, or combinations thereof.

In some embodiments, the brace implant is a material selected from brass, stainless steel, carbon and manganese steel, bronze, manganese bronze, cubic boron nitride, carbon nitride, carbide, cermet, copper-nickel alloy, copper-aluminum bronze alloy, copper-beryllium bronze alloys, or combinations thereof.

In some embodiments, the cross-support is a material selected from acrylonitrile butadiene styrene, high density polyethylene, ultra-high molecular weight polyethylene, high density polyurethane, high density fluorinated plastics, polyoxymethylene, polyimide, high impact polystyrene, polyamide, polyamide-imide, polybutylene terephthalate, polyetheretheketone, polyethylene terephthalate, layered para-aramid synthetic fiber sheets, or combinations thereof.

In some embodiments, the elongate handle is a material selected from carbon fiber, fiberglass, carbon fiber and fiber glass composite, high density polyethylene, or combinations thereof.

In some embodiments, the handle cover is a material selected from woven para-aramid synthetic fiber, woven carbon fiber, woven fiberglass, or combinations thereof.

In some embodiments, the hard neck cover is a material selected from high density polyethylene, ultra-high molecular weight polyethylene, high density polyurethane, high density fluorinated plastics, polyoxymethylene, polyimide, high impact polystyrene, polyamide, polyamide-imide, polybutylene terephthalate, polyetheretheketone, polyethylene terephthalate, or combinations thereof.

In some embodiments, the end cap is material selected from high density polyethylene, ultra-high molecular weight polyethylene, high density polyurethane, high density fluorinated plastics, polyoxymethylene, polyimide, high impact polystyrene, polyamide, polyamide-imide, polybutylene terephthalate, polyetheretheketone, polyethylene terephthalate, or combinations thereof.

In some embodiments of the present disclosure, the railroad brake stick may include the head where the head may include an engageable member on the proximal end and the lower side of the head. Further, the engageable member may be configured to insert into the first end of the substantially hollow shaft. The railroad brake stick, from the head to the end cap may be at least five (5) feet long, may weigh less than two (2) pounds, and may include at least one of a red or yellow coloring.

In some embodiments of the present disclosure, the end cap may include an outward facing portion including a base with a polygonal or circular cross section tapering to a nose. Additionally or alternatively, the polygonal or circular cross section of the base may be larger than a second cross-section of the substantially hollow shaft. The end cap may include an engageable member protruding from the base opposite the nose and, in particular, the nose of the end cap may be rounded. Further, the nose may be configured to couple the end cap to a substantially hollow shaft. In some embodiments, the engageable member may include three or more arms intersecting at a central axis region, a respective lateral side opposite the central axis region corresponding to each of the three or more arms, and each of the respective lateral sides including a plurality of notches. Additionally, a chamber may be formed between each of the three or more arms when inserted into the substantially hollow shaft.

In some embodiments of the present disclosure, the base with a polygonal or circular cross section may include a recess. The recess may include a lateral dimension that may be wider than the widest lateral dimension of the engageable member. The recess in the base of the end cap may be configured to receive at least a portion of the substantially hollow shaft. The engageable member of the end cap may additionally be at least as long as the length from the base of the end cap to the nose of the end cap.

In some embodiments of the present disclosure, a method of making a railroad brake stick may include forming, providing, and/or obtaining a head of the railroad brake stick. The head may include a planar shape with a proximal end, a distal end, a lower side, and an upper side. The lower side of the head may include a curved recess and a protrusion on the distal end and on the upper side of the head. In these and other embodiments, the method of making a railroad brake stick may further include forming, providing, and/or obtaining a substantially hollow shaft that may include a first end and a second end. In some embodiments, the method may include coupling the head to the first end of the substantially hollow shaft. In some embodiments, the method may additionally include forming, providing, and/or obtaining an end cap, the end cap may include an outward facing portion that may include a base with a circular cross section tapering to a nose. The end cap may additionally include an engageable member protruding from the base opposite the nose. In some embodiments, the method may additionally include coupling the end cap to the second end of the substantially hollow shaft using a binder.

In these and other embodiments of the present disclosure, the engageable member of the end cap may include three (3) or more arms intersecting at a central axis region. Further, the engageable member may include a respective lateral side opposite the central axis region corresponding to each of the three or more arms. Additionally or alternatively, each of the respective lateral sides may include a plurality of notches, wherein a chamber may be formed between each of the three (3) or more arms when inserted into the substantially hollow shaft. The end cap may be coupled to the substantially hollow shaft using a binder, the method may include applying the binder to the engageable member of the end cap or inside the second end of the substantially hollow shaft. Further, the method may include coupling the end cap to the second end of the substantially hollow shaft by inserting the engageable member of the end cap into the second end of the substantially hollow shaft.

In some embodiments of the present disclosure, prior to applying the binder to the engageable member of the end cap or inside the second end of the substantially hollow shaft, the method may include providing one or more layers of a composite material. Further, the provided one or more layers of the composite material may be applied to an outer surface of the substantially hollow shaft. Additionally, the composite material may be folded into the second end of the substantially hollow shaft. The engageable member may then be inserted into the second end of the substantially hollow shaft including folded portions of the composite material.

In some embodiments of the present disclosure, the plurality of notches may allow for the binder to flow between each gap between the arms and an internal surface of the substantially hollow shaft, and the method may include applying enough of the binder to at least partially fill each chamber between each of the three (3) of more arms. Additionally or alternatively, the method may include inserting the engageable member of the end cap into the second end of the substantially hollow shaft such that the second end of the substantially hollow shaft connects with the base of the end cap in the recess.

One skilled in the art will appreciate that, for the processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

As used, herein the phrase “second material having a second hardness that is harder than the first hardness” indicates the second material has a harness property that is harder than the first material. For example, the first material may be a plastic and the second material may be a metal. The hardness may be a calculated hardness or a durability to wear. As such, wear resistance can be a measure of hardness for the first material relative to the second material. The hardness can be resistance to indentation or other deformation, such a load or scratching. Mohs scale can be used to determine the relative hardness of the first material to the second material.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

What is claimed is:

1. A railroad brake stick comprising:
a head including a planar body with a working region having a perimeter head shape with at least one working surface and with a hilt region having a hilt slot;
a cross-support including a planar body with a support slot that mates with the hilt slot to form an interlocking coupling;
an elongate handle with a substantially hollow shaft having a first end and a second end, the first end having a first opening receiving the hilt region and cross-support to have the interlocking coupling located within a lumen of the hollow shaft;
a binder in contact with the lumen of the hollow shaft and in contact with the hilt region and cross-support so as to couple the hilt region and cross-support to the lumen of the hollow shaft;
a handle cover over the elongate handle, wherein the elongate handle cover is a woven fiber;
at least one magnet coupled to the elongate handle and covered by the handle cover; and
an end cap coupled to the second end of the elongate handle.

2. The railroad brake stick of claim 1, further comprising a brace implant that is received into an implant slot formed into the working surface of the planar body of the head, wherein the brace implant is made of a material that is harder than a material of the head.

3. The railroad brake stick of claim 2, wherein the brace implant includes a concave working surface that exposed from the head.

4. The railroad brake stick of claim 3, wherein the concave working surface has a notch formed therein.

5. The railroad brake stick of claim 1, wherein a neck region of the end cap is configured to be inserted into the second end of the hollow shaft, and a second binder is in contact with the lumen of the hollow shaft in contact with the neck region so as to couple the neck region to the lumen of the hollow shaft, wherein the binder and second binder are same or different.

6. The railroad brake stick of claim 5, wherein a portion the handle cover extends over the second end of the hollow shaft and is tucked into the second end of the lumen, and the second binder binds the neck region to the portion of the handle cover within the lumen of the handle.

7. The railroad brake stick of claim 5, wherein a neck region of the end cap is configured with a plurality of support wings that define regions to retain the second binder.

8. The railroad brake stick of claim 1, further comprising a magnet brace for each magnet, each magnet brace having a magnet chamber retaining a respective magnet therein, the magnet brace having an internal surface with a contour that matches a contour of the elongate handle, wherein the magnet brace is covered by the handle cover.

9. The railroad brake stick of claim 1, further comprising a hard neck cover having a conduit extending from an open tapered neck to an open end, the open tapered neck receiving the hilt region therethrough so as to retain the interlocking coupling withing within the conduit.

10. The railroad brake stick of claim 9, wherein the conduit at the open tapered neck has opposing surfaces that braced respective hilt surfaces and recesses formed into the opposing surfaces that receive the cross-support.

11. The railroad brake stick of claim 10, wherein a portion the handle cover extends over the first end of the hollow shaft and is tucked into the first end of the lumen, the handle cover being between the at least a portion the lumen of the handle and the interlocking coupling, and the binder binds the portion of the handle cover with the interlocking coupling within the lumen of the handle.

12. The railroad brake stick of claim 9, further comprising a light reflective member coupled with at least one of the head, hard neck cover, or handle cover.

13. The railroad brake stick of claim 9, further comprising a phosphorescent member coupled with at least one of the head, hard neck cover, or handle cover.

14. The railroad brake stick of claim 12, further comprising a translucent cover over the light reflective member that is coupled with at least one of the head, hard neck cover, or handle cover.

15. The railroad brake stick of claim 13, further comprising a translucent cover over the phosphorescent member that is coupled with at least one of the head, hard neck cover, or handle cover.

16. The railroad brake stick of claim 1, wherein the handle cover includes a color at least one of red, pink orange, green, or yellow coloring, whether fluorescent, phosphorescent or non-florescent.

17. A railroad brake stick comprising:
a head including a planar body with a working region having a perimeter head shape with at least one working surface and with a hilt region having a hilt slot;
a brace implant that is received into an implant slot formed into the working surface of the planar body of the head, wherein the brace implant is made of a material that is harder than a material of the head, wherein the brace implant includes a concave working surface that exposed from the head, wherein the concave working surface has a notch formed therein;
a cross-support including a planar body with a support slot that mates with the hilt slot to form an interlocking coupling;
an elongate handle with a substantially hollow shaft having a first end and a second end, the first end having a first opening receiving the hilt region and cross-support to have the interlocking coupling located within a lumen of the hollow shaft;
a binder in contact with the lumen of the hollow shaft and in contact with the hilt region and cross-support so as to couple the hilt region and cross-support to the lumen of the hollow shaft;
a handle cover over the elongate handle, wherein the elongate handle cover is a woven fiber, wherein a portion the handle cover extends over the second end of the hollow shaft and is tucked into the second end of the lumen, and a second binder binds a neck region to the portion of the handle cover within the lumen of the handle, wherein a portion the handle cover extends over the first end of the hollow shaft and is tucked into the first end of the lumen;
at least one magnet coupled to the elongate handle and covered by the handle cover, a magnet brace for each magnet, each magnet brace having a magnet chamber retaining a respective magnet therein, the magnet brace having an internal surface with a contour that matches a contour of the elongate handle, wherein the magnet brace is covered by the handle cover;
a hard neck cover having a conduit extending from an open tapered neck to an open end, the open tapered neck receiving the hilt region therethrough so as to retain the interlocking coupling withing within the conduit, wherein the conduit at the open tapered neck has opposing surfaces that braced respective hilt surfaces and recesses formed into the opposing surfaces that receive the cross-support; and
an end cap coupled to the second end of the elongate handle, wherein a neck region of the end cap is configured with a plurality of support wings that define regions to retain the second binder and is inserted into the second end of the hollow shaft, and a second binder is in contact with the lumen of the hollow shaft in contact with the neck region so as to couple the neck region to the lumen of the hollow shaft, wherein the binder and second binder are the same or different.

18. The railroad brake stick of claim 17, further comprising at least one of a light reflective member or a phosphorescent member coupled with at least one of the head, hard neck cover, or handle cover.

19. The railroad brake stick of claim 18, wherein the handle cover includes a color at least one of red, pink orange, green, or yellow coloring, whether fluorescent, phosphorescent or non-florescent.

20. The railroad brake stick of claim 17, wherein at least one of:
the head is a material selected from high density polyethylene, ultra-high molecular weight polyethylene, high density polyurethane, high density fluorinated plastics, polyoxymethylene, polyimide, high impact polystyrene, polyamide, polyamide-imide, polybutylene terephthalate, polyetheretheketone, polyethylene terephthalate, layered para-aramid synthetic fiber sheets, or combinations thereof;
the brace implant is a material selected from brass, stainless steel, carbon and manganese steel, bronze, manganese bronze, cubic boron nitride, carbon nitride, carbide, cermet, copper-nickel alloy, copper-aluminum bronze alloy, copper-beryllium bronze alloys, or combinations thereof;
the cross-support is a material selected from acrylonitrile butadiene styrene, high density polyethylene, ultra-high molecular weight polyethylene, high density polyurethane, high density fluorinated plastics, polyoxymethylene, polyimide, high impact polystyrene, polyamide, polyamide-imide, polybutylene terephthalate, polyetheretheketone, polyethylene terephthalate, layered para-aramid synthetic fiber sheets, or combinations thereof;
the elongate handle is a material selected from carbon fiber, fiberglass, carbon fiber and fiber glass composite, high density polyethylene, or combinations thereof;
the handle cover is a material selected from woven para-aramid synthetic fiber, woven carbon fiber, woven fiberglass, or combinations thereof;
the hard neck cover is a material selected from high density polyethylene, ultra-high molecular weight polyethylene, high density polyurethane, high density fluorinated plastics, polyoxymethylene, polyimide, high impact polystyrene, polyamide, polyamide-imide, polybutylene terephthalate, polyetheretheketone, polyethylene terephthalate, or combinations thereof; or
the end cap is material selected from high density polyethylene, ultra-high molecular weight polyethylene, high density polyurethane, high density fluorinated plastics, polyoxymethylene, polyimide, high impact polystyrene, polyamide, polyamide-imide, polybutylene terephthalate, polyetheretheketone, polyethylene terephthalate, or combinations thereof.
